(19) United States
(12) Patent Application Publication
(10) Pub. No.: US 2018/0371811 A1
(43) Pub. Date: Dec. 27, 2018

(54) HINGE ASSEMBLY FOR REFRIGERATOR DOOR BODY AND REFRIGERATOR

(71) Applicant: QINGDAO HAIER JOINT STOCK CO., LTD., Qingdao City, Shandong Province (CN)

(72) Inventors: HAO ZHANG, Qingdao City, Shandong Province (CN); ENPIN XIA, Qingdao City, Shandong Province (CN); XIAOBING ZHU, Qingdao City, Shandong Province (CN)

(21) Appl. No.: 16/065,818

(22) PCT Filed: Jun. 17, 2016
(86) PCT No.: PCT/CN2016/086174

§ 371 Date: Jun. 25, 2018

(30) Foreign Application Priority Data
Dec. 29, 2015 (CN) 201511023263.5

(51) Int. Cl. E05D 3/14; E05D 5/06

(52) U.S. Cl. CPC E05D 3/14; E05D 5/06

(57) ABSTRACT

A hinge assembly used for a door body of a refrigerator. The hinge assembly (3) comprises a first fixing base, a second fixing base, a first connecting rod and a second connecting rod. The first connecting rod and the second connecting rod are connecting the first fixing base with the second fixing base. The rear end of the first connecting rod and the rear end of the second connecting rod both extend into a space formed in the first fixing base and are rotationally connected to the first fixing base. The front end of the first connecting rod and the front end of the second connecting rod are rotationally connected to the second fixing base. When the door body is opened or closed, the rotation angle of the first connecting rod relative to the first fixing base and the rotation angle of the second connecting rod are consistent.

### TECHNICAL FIELD

The present disclosure relates to the field of refrigerator manufacturing, and in particular, to a refrigerator and a hinge assembly for a door body of the refrigerator.

### BACKGROUND

With the gradual improvement of living standards, users have higher demands for the use experience of refrigerators. A door body of the traditional refrigerator is opened through rotation around a predetermined rotation shaft, such that the structure is simple. In view of this, Chinese patent application No: CN201110446465.6 in the industry has disclosed a side-by-side dew-proof refrigerator, in which, through the cooperation of a rolling wheel and a guide rail, the door is pushed to both sides when it needs to be opened, without affecting the user's sight and saving front and back spaces. However, with the repeated opening and closing of the door body, the sealing of the door body may be reduced, thereby affecting the use.

Therefore, it is necessary to provide a novel refrigerator and a novel hinge assembly for a door body of a refrigerator.

### SUMMARY

An objective of the present disclosure is to provide a refrigerator and a hinge assembly for a door body of the refrigerator. According to the refrigerator and the hinge assembly of the present disclosure, a door opening mode of a door body of an existing refrigerator is changed to improve the user experience.

To fulfill said objective of the present disclosure, the present disclosure provides a hinge assembly for a door body of a refrigerator, comprising a first fixing base to be installed to a refrigerator body of the refrigerator, a second fixing base to be installed to the door body, as well as a first connection rod and a second connection rod for connecting the first fixing base with the second fixing base, wherein

a space is formed in the first fixing base, and the rear end of the first connection rod and the rear end of the second connection rod both extend into the space and are rotationally connected to the first fixing base;

the front end of the first connection rod and the front end of the second connection rod are rotationally connected to the second fixing base; and

when the door body is opened or closed, the rotation angle of the first connection rod and the rotation angle of the second connection rod with respect to the first fixing base are consistent.

As an improvement of the present disclosure, the first fixing base is provided with a first rotation shaft and a second rotation shaft in a longitudinal direction, wherein the first rotation shaft passes through the rear end of the first connection rod, such that the first connection rod is rotatable along the first rotation shaft; the second rotation shaft passes through the rear end of the second connection rod, such that the second connection rod is rotatable along the second rotation shaft.

As a further improvement of the present disclosure, one end of the second fixing base, which is connected with the first connection rod, protrudes backwards to form a clamping portion; the clamping portion is provided with two clamping arms which face each other vertically; each clamping arm is provided with a connection hole; the front end of the first connection rod extends into the clamping portion, and protrudes upwards and downwards to form a third rotation shaft matched with the connection hole; the first connection rod is rotatable along the third rotation shaft.

As a further improvement of the present disclosure, the other end of the second fixing base is provided with a fourth rotation shaft in a longitudinal direction, the fourth rotation shaft passing through the front end of the second connection rod; the second connection rod is arranged to be rotatable along the fourth rotation shaft.

As a further improvement of the present disclosure, the first rotation shaft and the second rotation shaft are located on the left end and the right end of the first fixing base respectively and are staggered in a front-back direction; the third rotation shaft and the fourth rotation shaft are located on the left end and the right end of the second fixing base respectively and are staggered in the front-back direction; a distance between the first rotation shaft and the third rotation shaft is identical with a distance between the second rotation shaft and the fourth rotation shaft.

As a further improvement of the present disclosure, the first rotation shaft is located on the rear side of the second rotation shaft, a limiting portion is formed on one end, which corresponds to the second rotation shaft, of the first fixing base, and when the door body is opened completely, an angle that the second connection rod rotates with respect to the second rotation shaft is the maximum and the second connection rod then props against the limiting portion.

As a further improvement of the present disclosure, the front end of the first connection rod is arc-shaped; the clamping arms of the clamping portion are arc-shaped in a horizontal direction and clamped to the front end of the first connection rod in a vertical direction.

As a further improvement of the present disclosure, a bent portion is formed on the second connection rod and configured to: when the door body is opened completely, be located between the third rotation shaft and the fourth rotation shaft in a left-right direction and have a gap with the clamping portion.

As a further improvement of the present disclosure, a horizontal height of the first fixing base and a horizontal height of the second fixing base are consistent.

The present disclosure further provides a refrigerator comprising a refrigerator body and a door body; the refrigerator comprises the hinge assembly; the first fixing base is fixed to the refrigerator body, and the second fixing base is fixed to the door body, wherein when the door body is opened or closed, a rotation angle of the first connection rod and a rotation angle of the second connection rod with respect to the first fixing base are consistent, and the door body always remains parallel to a plane wherein an opening of the refrigerator body is located in the opening or closing process of the door body.

The present disclosure has the following beneficial effects: by the adoption of the refrigerator and the hinge assembly for the door body of the refrigerator, the door body is driven to be opened or closed under the combined rotation of the first connection rod and the second connection rod, such that the structure is stable, and therefore the door opening mode of the door body of the existing refrigerator is changed to improve the user experience.

### BRIEF DESCRIPTION OF THE DRAWINGS

FIG. 1 is a schematic diagram of a state in which the door body of the refrigerator of the present disclosure is opened;

FIG. 2 is a schematic planar diagram of the hinge assembly for the door body of the refrigerator of the present disclosure when the door body is closed;

FIG. 3 is a schematic planar diagram of the hinge assembly for the door body of the refrigerator of the present disclosure when the door body is opened; and

FIG. 4 is an exploded schematic diagram of the hinge assembly for the door body of the refrigerator of the present disclosure.

### DETAILED DESCRIPTION

The present disclosure will be described below in detail with reference to the embodiments shown in the drawings. However, these embodiments do not limit the present disclosure. Modifications to the structure, method or function based on these embodiments made by those skilled in the art are all also included in the protection scope of the present disclosure. “Front”, “back”, “left”, and “right” are all described with reference to the direction of the refrigerator of the present disclosure toward a user and in combination with the drawings.

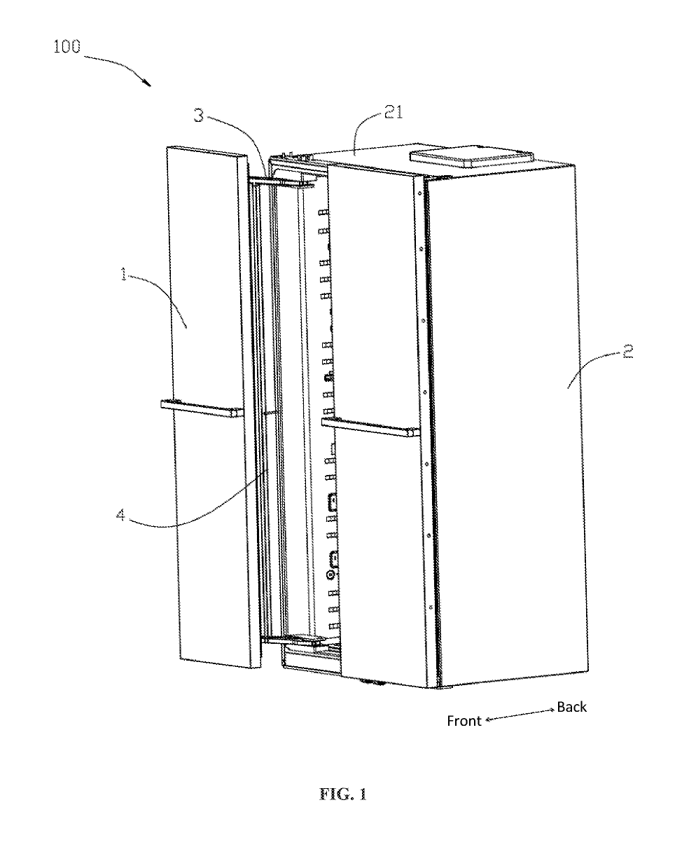

FIG. 1 is a schematic diagram of a state in which the door body 1 of the refrigerator 100 of the present disclosure is opened. The refrigerator 100 comprises a door body 1 and a refrigerator body 2, as well as a hinge assembly 3 arranged between the door body 1 and the refrigerator body 2 and used for connecting the door body 1 with the refrigerator body 2.

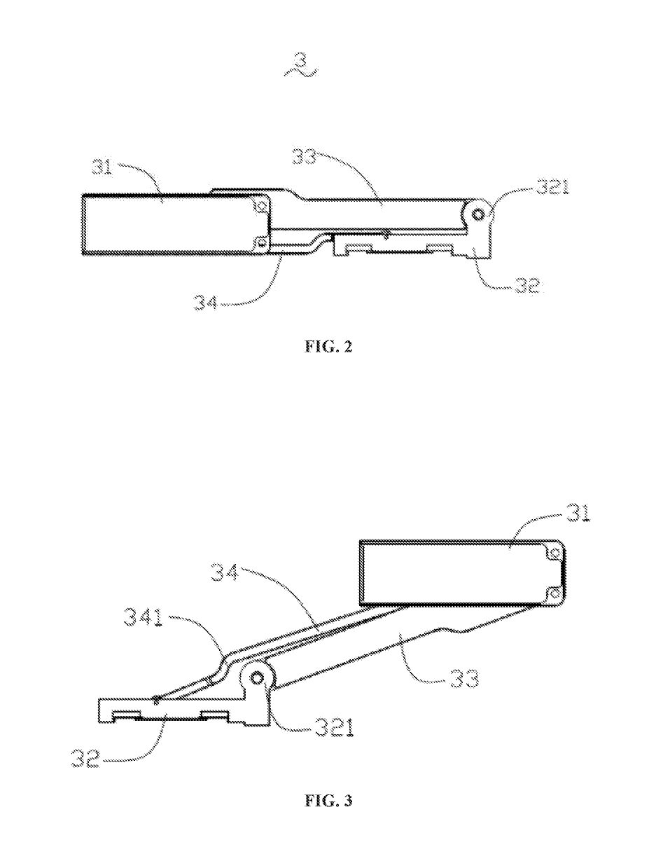

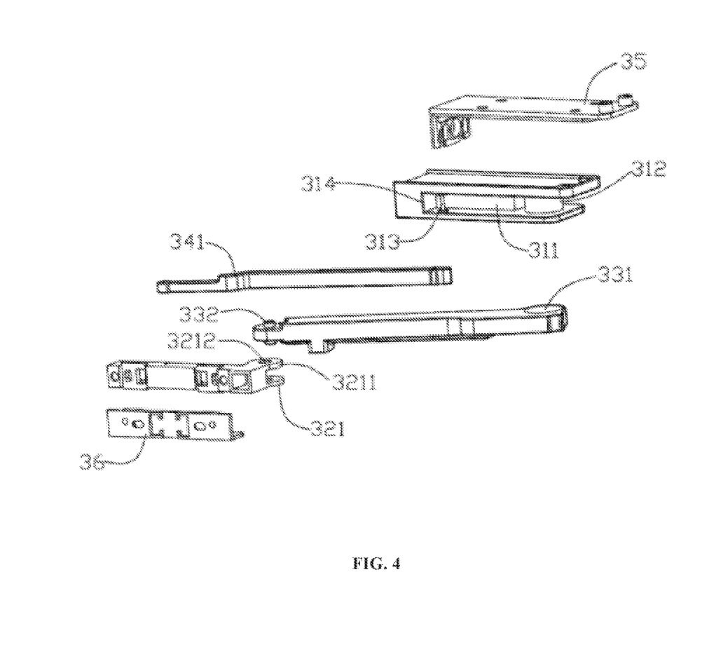

Referring to FIGS. 1 to 4, the hinge assembly 3 comprises a first fixing base 31 installed to the refrigerator body 2, a second fixing base 32 installed to the door body 1, as well as a first connection rod 33 and a second connection rod 34 for connecting the first fixing base 31 with the second fixing base 32. A space 311, which faces forwards and is arranged in the direction opposite to the opening direction of the door body 1, is formed in the first fixing base 31. The rear end of the first connection rod 33 and the rear end of the second connection rod 34 both extend into the space 311 and are rotationally connected to the first fixing base 31. The front end of the first connection rod 33 and the front end of the second connection rod 34 are rotationally connected to the second fixing base 32.

In the present embodiment, a horizontal height of the first fixing base 31 and a horizontal height of the second fixing base 32 are consistent. A first rotation shaft 312 is formed at a position, which is connected with the first connection rod 33, of the first fixing base 31 in a longitudinal direction. The rear end of the first connection rod 33 is provided with a hole 331 penetrating vertically. The first rotation shaft 312 passes through the hole 331, such that the first connection rod 33 is rotatable along the first rotation shaft 312. A second rotation shaft 313 which passes through the rear end of the second connection rod 34 is also arranged at a position, which is connected with the second connection rod 34, of the first fixing base 31 in a longitudinal direction. The second connection rod 34 is arranged to be rotatable along the second rotation shaft 313. The first rotation shaft 312 and the second rotation shaft 313 are located on the left end and the right end of the first fixing base 31 respectively and are staggered in a front-back direction.

One end of the second fixing base 32, which is connected with the first connection rod 33, protrudes backwards to form a clamping portion 321. The clamping portion 321 is provided with two clamping arms 3211 which face each other vertically. The clamping arms 3211 are arc-shaped in a horizontal direction and clamped to the front end of the first connection rod 33 in a vertical direction. The front end of the first connection rod 33 is arc-shaped and has a thickness matched with a distance between the clamping arms 3211. Each clamping arm 3211 is provided with a connection hole 3212. The front end of the first connection rod 33 extends into the clamping portion 321, and protrudes upwards and downwards to form a third rotation shaft 332 matched with the connection hole 3212. The first connection rod 33 is rotatable along the third rotation shaft 332. The other end of the second fixing base 32 is provided with a fourth rotation shaft 322 in a longitudinal direction, the fourth rotation shaft 322 passing through the front end of the second connection rod 34. The second connection rod 34 is arranged to be rotatable along the fourth rotation shaft 322. The third rotation shaft 332 and the fourth rotation shaft 322 are located on the left end and the right end of the second fixing base 32 and are staggered in the front-back direction.

A distance between the first rotation shaft 312 and the third rotation shaft 332 is identical with a distance between the second rotation shaft 313 and the fourth rotation shaft 322. When the door body 1 is opened or closed, a rotation angle of the first connection rod 33 and a rotation angle of the second connection rod 34 with respect to the first fixing base 31 are consistent, and the door body 1 always remains parallel to a plane wherein an opening of the refrigerator body 2 is located in the opening or closing process of the door body 1.

The first rotation shaft 312 is correspondingly located on the rear side of the second rotation shaft 313. A limiting portion 314 is also formed on one end, which corresponds to the second rotation shaft 313, of the first fixing base 31, and when the door body 1 is opened completely, an angle that the second connection rod 34 rotates with respect to the second rotation shaft 313 is the maximum and the second connection rod 34 then props against the limiting portion 314. A bent portion 341 is formed on the second connection rod 34 and configured to: when the door body 1 is opened completely, be located between the third rotation shaft 332 and the fourth rotation shaft 322 in the left-right direction and have a gap with the clamping portion 321.

The hinge assembly 3 is arranged on each of the upper side and the lower side of the door body 1. Each hinge assembly 3 also comprises a first fixing base 35 used for fixedly installing the first fixing base 31 to a top wall 21 of the refrigerator body 2, and a second mounting base 36 for fixedly installing the second fixing base 32 to the door body 1. The refrigerator 100 further comprises a connection rod 4 for connecting the hinge assemblies 3 on the upper side and the lower side. The connection rod 4 is fixedly connected to the first connection rod 33. As such, the opening and closing process of the door body 1 is more stable, and the requirement for front and back spaces when the door body 1 is opened is reduced effectively.

In light of above, by the adoption of the hinge assembly 3 and the refrigerator 100 of the present disclosure, the door body 1 is driven to be opened or closed under the combined rotation of the first connection rod 33 and the second connection rod 34, such that the structure is stable, and therefore the door opening mode of the door body of the existing refrigerator is changed to improve the user experience.

It should be understood that although the description is described according to the above embodiments, each embodiment may not only include one independent technical solution. The presentation manner of the description is only for the sake of clarity. Those skilled in the art should take the description as an integral part. The technical solutions of the respective embodiments may be combined properly to form other embodiments understandable by those skilled in the art.

The above detailed description only illustrates the feasible embodiments of the present disclosure, and is not intended to limit the protection scope of the present disclosure. Equivalent embodiments or modifications within the scope and spirit of the present disclosure shall be embraced by the protection scope of the present disclosure.

1. A hinge assembly for a door body of a refrigerator, comprising a first fixing base to be installed to a refrigerator body of the refrigerator, a second fixing base to be installed to the door body, as well as a first connection rod and a second connection rod for connecting the first fixing base with the second fixing base, wherein:
a space is formed in the first fixing base, and the rear end of the first connection rod and the rear end of the second connection rod both extend into the space and are rotationally connected to the first fixing base;
the front end of the first connection rod and the front end of the second connection rod are rotationally connected to the second fixing base; and
when the door body is opened or closed, the rotation angles of the first connection rod and the second connection rod with respect to the first fixing base are consistent.

2. The hinge assembly according to claim 1, wherein the first fixing base is provided with a first rotation shaft and a second rotation shaft in a longitudinal direction, wherein the first rotation shaft passes through the rear end of the first connection rod, such that the first connection rod is rotatable along the first rotation shaft; the second rotation shaft passes through the rear end of the second connection rod, such that the second connection rod is rotatable along the second rotation shaft.

3. The hinge assembly according to claim 2, wherein one end of the second fixing base, which is connected with the first connection rod, protrudes backwards to form a clamping portion; the clamping portion is provided with two clamping arms which face each other vertically; each clamping arm is provided with a connection hole; the front end of the first connection rod extends into the clamping portion, and protrudes upwards and downwards to form a third rotation shaft matched with the connection hole; the first connection rod is rotatable along the third rotation shaft.

4. The hinge assembly according to claim 3, wherein the other end of the second fixing base is provided with a fourth rotation shaft in a longitudinal direction, the fourth rotation shaft passing through the front end of the second connection rod; the second connection rod is arranged to be rotatable along the fourth rotation shaft.

5. The hinge assembly according to claim 4, wherein the first rotation shaft and the second rotation shaft are located on the left end and the right end of the first fixing base respectively and are staggered in a front-back direction; the third rotation shaft and the fourth rotation shaft are located on the left end and the right end of the second fixing base and are staggered in the front-back direction; a distance between the first rotation shaft and the third rotation shaft is identical with a distance between the second rotation shaft and the fourth rotation shaft.

6. The hinge assembly according to claim 2, wherein the first rotation shaft is located on the rear side of the second rotation shaft, a limiting portion is formed on one end, which corresponds to the second rotation shaft, of the first fixing base, and when the door body is opened completely, an angle that the second connection rod rotates with respect to the second rotation shaft is the maximum and the second connection rod then props against the limiting portion.

7. The hinge assembly according to claim 3, wherein the front end of the first connection rod is arc-shaped, and the clamping arms of the clamping portion are arc-shaped in a horizontal direction and clamped to the front end of the first connection rod in a vertical direction.

8. The hinge assembly according to claim 3, wherein a bent portion is formed on the second connection rod and configured to: when the door body is opened completely, be located between the third rotation shaft and the fourth rotation shaft in a left-right direction and have a gap with the clamping portion.

9. The hinge assembly according to claim 1, wherein the horizontal heights of the first fixing base and the second fixing base are consistent.

10. A refrigerator comprising a refrigerator body and a door body, wherein the refrigerator comprises a hinge assembly, the hinge assembly comprises a first fixing base to be installed to a refrigerator body of the refrigerator, a second fixing base to be installed to the door body, as well as a first connection rod and a second connection rod for connecting the first fixing base with the second fixing base; wherein
a space is formed in the first fixing base, and the rear end of the first connection rod and the rear end of the second connection rod both extend into the space and are rotationally connected to the first fixing base;
the front end of the first connection rod and the front end of the second connection rod are rotationally connected to the second fixing base; and
when the door body is opened or closed, the rotation angles of the first connection rod and the second connection rod with respect to the first fixing base are consistent
the first fixing base is fixed to the refrigerator body, and the second fixing base is fixed to the door body, wherein when the door body is opened or closed, a rotation angle of the first connection rod and a rotation angle of the second connection rod with respect to the first fixing base are consistent, and the door body always remains parallel to a plane wherein an opening of the refrigerator body is located in the opening or closing process of the door body.

11. The refrigerator according to claim 10, wherein the first fixing base is provided with a first rotation shaft and a second rotation shaft in a longitudinal direction, wherein the first rotation shaft passes through the rear end of the first connection rod, such that the first connection rod is rotatable along the first rotation shaft; the second rotation shaft passes through the rear end of the second connection rod, such that the second connection rod is rotatable along the second rotation shaft.

12. The refrigerator according to claim 11, wherein one end of the second fixing base, which is connected with the first connection rod, protrudes backwards to form a clamping portion; the clamping portion is provided with two clamping arms which face each other vertically; each clamping arm is provided with a connection hole; the front end of the first connection rod extends into the clamping portion, and protrudes upwards and downwards to form a third rotation shaft matched with the connection hole; the first connection rod is rotatable along the third rotation shaft.

13. The refrigerator according to claim 12, wherein the other end of the second fixing base is provided with a fourth rotation shaft in a longitudinal direction, the fourth rotation shaft passing through the front end of the second connection rod; the second connection rod is arranged to be rotatable along the fourth rotation shaft.

14. The refrigerator according to claim 13, wherein the first rotation shaft and the second rotation shaft are located on the left end and the right end of the first fixing base respectively and are staggered in a front-back direction; the third rotation shaft and the fourth rotation shaft are located on the left end and the right end of the second fixing base and are staggered in the front-back direction; a distance between the first rotation shaft and the third rotation shaft is identical with a distance between the second rotation shaft and the fourth rotation shaft.

15. The refrigerator according to claim 11, wherein the first rotation shaft is located on the rear side of the second rotation shaft, a limiting portion is formed on one end, which corresponds to the second rotation shaft, of the first fixing base, and when the door body is opened completely, an angle that the second connection rod rotates with respect to the second rotation shaft is the maximum and the second connection rod then props against the limiting portion.

16. The refrigerator according to claim 12, wherein the front end of the first connection rod is arc-shaped, and the clamping arms of the clamping portion are arc-shaped in a horizontal direction and clamped to the front end of the first connection rod in a vertical direction.

17. The refrigerator according to claim 12, wherein a bent portion is formed on the second connection rod and configured to: when the door body is opened completely, be located between the third rotation shaft and the fourth rotation shaft in a left-right direction and have a gap with the clamping portion.

18. The refrigerator according to claim 10, wherein the horizontal heights of the first fixing base and the second fixing base are consistent.
